(19) United States
(12) Patent Application Publication
(10) Pub. No.: US 2025/0021908 A1
(43) Pub. Date: Jan. 16, 2025

(54) COMPUTER-IMPLEMENTED AI ASSISTANT, COMPUTER-IMPLEMENTED EDUCATIONAL PLATFORM, AND METHOD OF HIERARCHICALLY PROCESSING DATA

(71) Applicant: The Trustees of Indiana University, Bloomington, IN (US)

(72) Inventor: Fawzi Ben Messaoud, Carmel, IN (US)

(21) Appl. No.: 18/769,158

(22) Filed: Jul. 10, 2024

Related U.S. Application Data
(60) Provisional application No. 63/512,812, filed on Jul. 10, 2023.

(51) Int. Cl. G06Q 10/0637; G06Q 50/20

(52) U.S. Cl. CPC G06Q 10/0637; G06Q 50/205

(57) ABSTRACT

Computer-implemented AI assistants, computer-implemented educational platforms, and methods of hierarchically processing data. Such an AI assistant includes an extraction module, a transform module, an integration module, and a manager module. The extraction module includes an AI data extraction agent that identifies and extracts relevant raw digital data from digital data sources. The transform module includes an AI data transformation agent that transforms the raw digital data into a usable form within the computer-implemented educational platform. The integration module includes an AI data integration agent that integrates the transformed data into a digital knowledge base. The manager module includes an AI agent that coordinates workflow of and dataflow between the extraction module, the transform module, and the integration module. The AI assistant may have a hierarchical structure that automates data processing from extraction to transformation to integration. The AI assistant can be implemented as part of a computer-implemented educational platform.

### CROSS-REFERENCE TO RELATED APPLICATIONS

This application claims the benefit of provisional U.S. Patent Application No. 63/512,812, filed Jul. 10, 2023, the contents of which are incorporated herein by reference.

### BACKGROUND OF THE INVENTION

The invention generally relates to computer-implemented AI (artificial intelligence) assistants and data processing methods. The invention particularly relates to computer-implemented AI assistants and hierarchically data processing methods capable of use in computer-implemented educational platforms.

In educational organizations, the use of computer-based virtual learning platforms has become ubiquitous. Such platforms typically provide a digital virtual space such that teachers can interact in real time (i.e., synchronously) and/or asynchronously with any number of students such that the students and teachers are not required to be physically located together in a particular physical classroom. Thus, these virtual learning platforms make it possible for students from widely dispersed locations to access educational opportunities that might otherwise be impracticable for them if they had to be physically present in a particular classroom with a particular teacher at a particular time. However, most conventional virtual learning platforms do little more than provide a video link between students and teachers to provide for synchronous interaction between students and teachers and possibly also provide an electronic messaging platform to allow asynchronous communications between students and teachers. While effective up to a point, these conventional virtual learning platforms often leave students and/or teachers faced with significant lag times when it comes to obtaining information because of the disconnect between the synchronous communication platforms and the asynchronous communication platforms, which can be an impediment to effective learning and/or efficient organizational management. Therefore, it would be desirable to have a new virtual learning platform that can overcome one or more of these limitations in the conventional virtual learning platform.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, computer-implemented artificial intelligence (AI) assistants, computer-implemented educational platforms, and methods of hierarchically processing data.

According to a nonlimiting aspect, a computer-implemented artificial intelligence (AI) assistant for a computer-implemented educational platform for an educational organization is provided. The computer-implemented educational platform is formed by one or more sets of software instructions executed by a computer system. The AI assistant includes an extraction module, a transform module, an integration module, and a manager module. The extraction module includes an AI data extraction agent configured to identify and extract raw digital data relevant to the educational organization from multiple digital data sources. The transform module includes an AI data transformation agent configured to receive the raw digital data from the extraction module and transform the raw digital data into transformed digital data having a usable form within the computer-implemented educational platform. The integration module includes an AI data integration agent configured to integrate the transformed data from the transform module into a digital knowledge base. The manager module includes an AI agent in charge that coordinates workflow of and dataflow between the extraction module, the transform module, and the integration module.

According to another nonlimiting aspect, a method of hierarchically processing data using the computer-implemented AI assistant described above is provided. The method includes extracting with the extraction module raw digital data from a digital data source, delivering the raw digital data from the extraction module to the transform module, transforming the raw digital data with the transform module into transformed digital data, delivering the transformed digital data from the transform module to the integration module, and mapping and storing with the integration module the transformed digital data received from the transform agent into the digital knowledge base.

The extraction module, the transform module, the integration module, and the manager module may have a hierarchical structure that automates data processing from extraction to transformation to integration. The dataflow may be, for example, from the extraction module to the transform module to the integration module, such that the extraction module delivers the raw digital data obtained from the digital data sources to the transform module, and the transform module delivers the transformed data to the integration module for loading into the digital knowledge base.

According to yet another nonlimiting aspect, a computer-implemented educational platform implementing software instructions executed by a computer system comprising one or more processors and digital memory storage is provided. The computer-implemented educational platform includes a user interface, a plurality of sources of raw digital data related to an educational organization, a digital knowledge base, and the computer-implemented AI assistant described above. The computer-implemented AI assistant interacts with each of the user interface, the plurality of sources of raw digital information, and the digital knowledge base to extract raw digital data from the plurality of sources, transform the raw digital data into transformed digital data, store the transformed digital data in the digital knowledge base, receive queries from the user interface, retrieve relevant information responsive to the queries from at least one of the plurality of sources and the digital knowledge base, and deliver the relevant information to the user.

The computer-implemented educational platform may include a query intelligent query module configured to implement a questioning protocol that includes interpreting the user's query, contextualizing the query by considering the surrounding context, identifying the most relevant data sources to address the query, executing the query across the identified most relevant data sources, compiling results obtained in response to the query, and generating a response for the user from the compiled results.

Technical aspects of a computer-implemented educational platform as described above preferably include the ability to provide a transformative framework designed to enhance teaching and learning experiences, and/or assist an educational organization to transition from traditional AI systems to organizational intelligence, providing comprehensive support for students, faculty, and administrative staff.

These and other aspects, arrangements, features, and/or technical effects will become apparent upon detailed inspection of the figures and the following description.

### BRIEF DESCRIPTION OF THE DRAWINGS

FIG. 1 is a block diagram representing a computer-implemented educational platform according to some nonlimiting aspects of the invention.

FIG. 2 is a block diagram of the computer-implemented educational platform of FIG. 1 incorporated and used within an educational organization.

FIG. 3 is a block diagram of a questioning protocol that implements a method of conducting intelligent queries in the computer-implemented educational platform of FIG. 1.

FIG. 4 is a block diagram of a method of collaborative workflow executed by a rapid training and tweaking model (RTT) model of the computer-implemented educational platform of FIG. 1.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

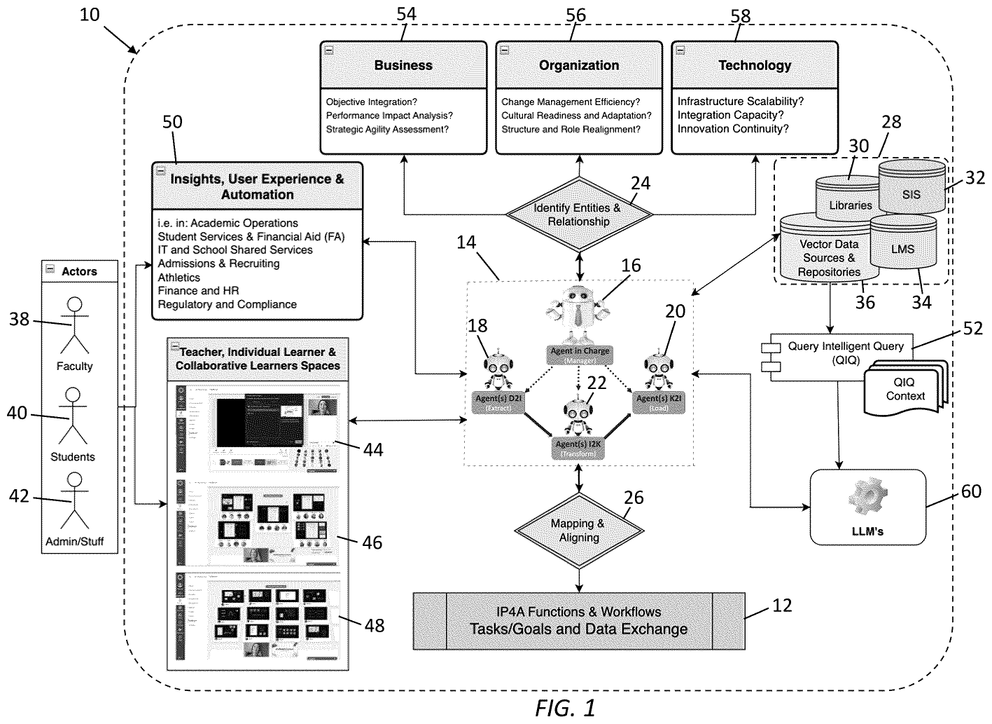

Turning now to FIG. 1, a computer implemented educational platform 10 (hereinafter, also the “platform”) includes an Intelligent P4 Cognitive Insights (“IP4I”) model 12 and a rapid training and tweaking (RTT) model 14. The platform 10 is preferably implemented on a digital computer system made up of one or more digital processors and digital memory storage, configured with hardware and/or software instructions that, when executed by the computer system cause the computer system to implement the various functions and methods described herein. The computer system may include several disparate computers, such as one or more central servers, dedicated digital processors, and/or individual user computers, interconnected by appropriate data communications links, such as internet, LANs, WLANs, etc., to allow the computers to interact with each other to implement the platform 10. The platform 10 engages with faculty, students, and administrative staff to create a collaborative learning environment.

In some nonlimiting embodiments, the platform 10 provides an educational system that utilizes human and artificial intelligence (AI) interactions in an educational context to achieve educational goals and improve education outcomes. The platform 10 includes simulated and interactive teaching and/or learning spaces on an infinite digital canvas. The infinite digital canvas creates a teaching and learning environment that facilitates both synchronous and asynchronous interaction and collaboration between a teacher and individual students of the teacher and among the students. An embedded AI assistant is configured to provide instant responses to inquiries of the students. The embedded AI assistant also automatically collects the student inquiries and learning analytics. The AI assistant also automates connectedness functions for the teacher with the students.

In other nonlimiting embodiments, the platform 10 facilitates methods to achieve educational goals and improve education outcomes in an educational context that utilizes human and artificial intelligence (AI) interactions. For example, such a method may include providing simulated and interactive teaching/learning spaces on an infinite digital canvas. The digital canvas may, for example, create a teaching and learning environment that facilitates synchronous and asynchronous interaction and collaboration between a teacher and individual students of the teacher and among the students. The method may further include providing an embedded AI assistant, such as in the form of the digital human, for interacting with students and/or teachers. The AI assistant may provide instant responses to inquiries of the students and automating the collection of the inquiries and learning analytics. The AI assistant may also automate connectedness functions for the teacher with the students.

The platform 10 provides a different interface for each of three different categories of users (“actors”) in an educational setting: teachers 38 (“faculty”), students 40, and administrators 42 (“admin/staff”). Each user can access an interface specific to that user or class of users. The teacher 38 accesses the platform 10 via a teacher interface 44 (“teacher space”). The student 40 accesses the platform 10 via either an individual learner interface 46 or a collaborative learners interface 48. The administrator 42 may access the platform 10 via any one of the interfaces 44, 46, and 48, or another interface specifically adapted for the administrator. Typically, the interfaces 44, 46, and 48 will be accessed at a remote computer by a user via secure internet web pages, local software application, or similar local access interface on an individual client computer, such as a desktop or laptop computer, smart mobile telephone, etc. In each of these interfaces 44, 46, and 48, the user interacts directly with the RTT model 14 to enter queries, receive responses to the queries, and/or access other automatically generated information, such as reports, dashboards, messages, reminders, etc. The interfaces 44, 46, and 48 thereby provide teacher spaces, individual learner spaces, and collaborative learners spaces that utilize an infinite digital canvas with tools and platforms to facilitate interactive learning and engagement. These spaces, using the platform 10, are able to provide personalized learning experiences real-time support for the students, teachers, and administrators, through the various AI agents described hereinafter.

The RTT model 14 (also referred to variously herein as a “digital human,” “AI agent,” or “AI assistant”) is a set of software modules having a hierarchical structure of various AI agents that allow it to enhance insights, user experience, and operational efficiency through automation. More specifically, the RTT model 14 optimizes the conversion of raw organizational data into actionable insights, enriches user experiences, and automates processes. The RTT model 14 includes a hierarchy of AI agents 16, 18, 20, 22, described hereinafter, with each AI agent being specialized in specific tasks, ensuring a seamless and efficient data transformation pipeline. The RTT model 14 includes three AI agent groups to perform its tasks efficiently and effectively: data extraction agents (e.g., extraction software module “D2I agent,” also called an extraction agent or extraction module) 18, data transformation agents (e.g., transform software module “12K agent,” also called a transformation agent or transform module) 22, and data integration agents (e.g., integration software module “K2I agent,” also called a loading agent or integration module) 20. The RTT model 14 also includes an AI manager agent called a manager software module (also called an “agent in charge” or manager module) 16 that coordinates the processes of the other three AI agent groups (18, 20, and 22) to work together to ensure that data is accurately collected, meaningfully transformed, and seamlessly integrated into the platform 10.

The RTT model 14 uses machine learning (ML) techniques and deep learning (DL) techniques to analyze data, revealing patterns, trends, and predictions across the entire educational organization. The RTT model 14 also enhances user interactions by using natural language processing (NLP), graphic user interfaces (GUIs), and/or computer vision technologies. The RTT model 14 also implements robotic process automation (RPA) that implements software bots to automate repetitive tasks and end-to-end processes. As discussed hereinbelow, the RTT model 14 preferably provides an AI assistant for interacting with the various human users of the platform 10, processing user inquiries, providing AI-generated responses to such inquiries, and administering other administrative and clerical tasks automatically based on the integrated sum of the organizational data and information provided to the RTT model 14.

The extraction module 18 includes one or more AI data extraction agents that are configured to identify and gather relevant digital data from multiple sources, ensuring accuracy and completeness. The extraction module 18 communicates with each of the interfaces 44, 46, and 48 as appropriate when engaged by a user to both receive raw input information from the respective user and to return output information to user as appropriate for the user's identity. In addition, the extraction module 18 receives raw data from one or more administrative databases 50 that include information from various departments and/or operational areas of an educational organization (e.g., a university, college, primary school, professional or trade school, certificate program provider, etc.). The administrative databases 50 typically include insights, user experience, and automation information relevant to the functioning of the educational organization. For example, the administrative databases 50 may information related to academic operations, student services, student financial aid, information technology services for the entity, shared services within the entity, admissions, recruiting, athletics, finance, human resources, regulatory information, compliance information, and/or other information relevant and/or used with the organization. The extraction module 18 identifies specific information needed and may actively query and/or extract the specific desired information from the administrative databases 50. The extraction module 18 (e.g., its data extraction agent(s)) utilizes machine learning algorithms to recognize and classify relevant data from structured and unstructured sources. The data extraction agent(s) employs web scraping, application programming interface (API) integration, and/or database queries to collect data in real-time or at scheduled intervals. The data extraction agent(s) provides data validation by verifying the integrity and accuracy of collected data through cross-referencing and error-checking mechanisms. The data extraction agent(s) provides the raw input information to the transform module 22 at the direction of the manager module 16. The data extraction agent(s) of the extraction module 18 coordinates with transformation agent(s) of the transform module 22 to ensure the data they collect meets the necessary (e.g., predefined) standards for further processing within the platform 10. The extraction module 18 also shares validated data with the transform module 22 in a standardized format to facilitate seamless data flow within the platform 10.

The transform module 22 includes one or more AI transformation agent(s) that receive the raw input data from the extraction module 18 and convert (transforms) the raw data into a usable form to ensure that the data is ready for analysis and decision-making to provide meaningful and actionable insights. The transform module 22 performs data cleaning, data enrichment, and data aggregation. Data cleaning removes duplicates, corrects errors, and handle missing values to prepare the data for analysis. Data enrichment enhances the dataset by adding context, such as temporal information or metadata, to make the data more informative. Data aggregation combines data from different sources to create comprehensive datasets that provide a holistic view of the subject matter. The transform module 22 works closely with the extraction module 18 to receive raw data and with integration agents to pass on the transformed data. The transform module 22 also provides standardization by applying consistent transformation protocols to ensure data uniformity, thereby making it easier to integrate and analyze throughout the platform 10. The transform module 22, delivers the transformed (converted) data to the integration module 20 and to a mapping and aligning module (mapping module) 26.

The integration module 20 includes one or more AI data integration agent(s) that integrate (“load”) the converted (transformed) data from the transform module 22 into a digital knowledge base 28, integration module 24, and/or other knowledge bases of the platform 10 to ensure the converted data is accessible, usable, and consistent. The knowledge database 28 may include, for example, one or more software library databases 30, digital SIS (student information system) databases 32, digital LMS (learning management system) databases 34, and/or digital vector data sources and repositories 36. The AI data integration agent(s) are configured for data mapping, data storage, and data accessibility. In data mapping, the data integration agent(s) align data from different sources to a common schema, facilitating integration and ensuring coherence. For data storage, the data integration agent(s) utilize databases and data warehouses to store integrated data, ensuring it is secure and easily retrievable. For data accessibility, the data integration agent(s) implement indexing and query optimization techniques to make data retrieval efficient and responsive. The integration agent(s) of the integration module 20 interface with both the transformation agent(s) of the transform module 22 and the extraction agent(s) of the extraction module 18 to maintain a seamless data pipeline within the platform 10. The integration agent(s) also continuously monitor various data storage systems to ensure they are operating efficiently, and that data is readily available for querying.

The manager module 16 (“agent in charge”) is a supervisory AI agent that supervises and coordinates the workflows of the other AI agents in the extraction module 18 (D2I), the transform module 22 (12K), and the integration module 20 (K2I) to ensure a collaborative workflow within the RTT model 14. The manager module 16 monitors and verifies each step, ensuring smooth operation and achieving desired outcomes. The manager module 16 communicates with each of the extraction module 18, the integration module 20, and the transform module 22. The manager module 16 also communicates with the integration module 24. The manager module 16 may be configured to coordinate the data extraction, data transformation and data integration functions of the respective modules 18, 22, and 20 into a collaborative workflow 300, as represented in FIG. 4. At 302, data extraction, the process begins with the data extraction agents of the extraction module 18 identifying and collecting relevant data from the various sources (e.g., 50, 28). The extracted data is then validated and the extraction agents share the extracted data with the transformation agents of the transform module 22. At 304, data transformation, the transformation agents of the transform module 22 receive the raw data from the extraction module 18 and perform cleaning, enrichment, and/or aggregation tasks. The transformed data is preferably also standardized at this stage for easy integration and use within the platform 10. Then the standardized transformed data is passed on to the integration agents of the integration module 20. At 306, data integration, the integration agents of the integration module 22 map and store the standardized transformed data received from the transform agent 22 in the digital knowledge base 28. The integration agents ensure that the standardized transformed data is accessible and query-ready for end-users.

Because of the hierarchical structure of the various AI agents in the RTT model 14, the manager module 16 can provide improved insights, user experience and efficiency. More specifically, by working together, the three agent groups (18, 20, and 22) ensure that data is accurately collected, transformed, and integrated, resulting in high-quality insights that are reliable and actionable. The standardized and enriched data allows for more comprehensive analysis and better decision-making. The users benefit from a seamless experience as the RTT model 14 ensures that data is readily available, accurate, and presented in a user-friendly manner. Real-time data processing and efficient query handling provide users with timely insights, enhancing their overall experience. Automation of data-related tasks reduces manual effort, minimizes errors, and speeds up the entire process, leading to significant operational efficiency gains. The collaborative workflow provided by the manager module 16 ensures that each module 18, 20, and 22 performs its tasks effectively, contributing to the overall effectiveness of the platform 10.

The hierarchical structure of the modules 16, 18, 20, and 22 and their respective AI agents in the RTT model 14, with distinct groups of AI agents for each of data extraction, transformation, and integration, and an overseeing “Agent in Charge” to coordinate and direct the functioning and dataflow of the other AI agents, provides detailed task specialization and integrated workflow. This hierarchical structure provides clear definition of the roles (functional tasks) of each AI agent group: data extraction (e.g., module 18), data transformation (e.g., module 22), and data integration (e.g., module 20). This clear delineation ensures that each AI agent group is specialized and optimized for its specific function. This task specialization, in which each layer of the hierarchy (modules 18, 20, and 22) is specialized in distinct, non-overlapping tasks, helps ensure that each separate function (extraction, transformation, integration) is performed by the most suitable AI agents, leading to greater efficiency and accuracy. The “Agent in Charge” (manager module 16) acts as a supervisory agent that oversees the entire process of the AI assistant 14 by monitoring and coordinating the activities of the other AI agents (modules 18, 20, and 22). This oversight adds a layer of coordination and oversight that enhances the efficiency and reliability of the system and helps ensure that any problematic issues are quickly identified and addressed, enhancing the overall reliability and effectiveness of the model. The supervisory AI agent (module 16) ensures seamless interaction and integration among the specialized agents (modules 18, 20, and 22). The hierarchical structure of the AI agents (modules 16, 18, 20, and 22) of the RTT model 14 provides an integrated workflow that ensures a smooth and continuous workflow, with each AI agent group (e.g., 18, 20, and 22) passing on data to the next stage in a streamlined manner. This hierarchical structure also provides end-to-end automation that automates the entire data processing pipeline, from extraction to transformation to integration, which can help improve insights, user experience, and operational efficiency within the entire educational organization.

A query intelligent query (QIQ) system 52 implements a questioning protocol that interacts with the vector data sources and repositories 36. The QIQ system 52 is a querying system that contextualizes queries to provide accurate and relevant insights for the various actors 38, 40, and 42 in the educational organization. This querying system is integral to the IP4I model 12, as it contextualizes and processes queries, for example from any of the users 38, 40, and 42, to provide accurate and relevant insights. This can ensure that the core functionality of the model is maintained. The QIQ system 52 enhances the interaction between the users (e.g., 38, 40, 42) and the various data repositories (e.g., 28, 50) by contextualizing and processing queries intelligently.

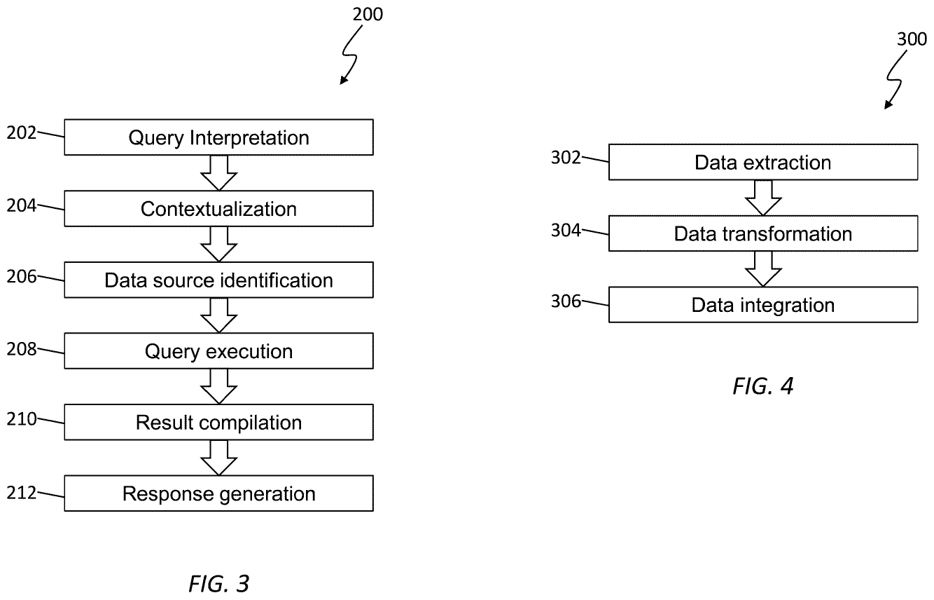

As seen in FIG. 3, the QIQ system 52 accomplishes this with a questioning protocol that implements a stepwise method 200 of contextualizing and processing queries. At query interpretation 202, the QIQ system 52 begins by interpreting the user's query. It uses natural language processing (NLP) techniques to understand the intent behind the query, identify keywords, and extract relevant entities. For example, if a user asks, “What is the impact of new policies on student performance?”, the QIQ system 52 will identify “new policies” and “student performance” as key entities. Next during contextualization 204, the QIQ system 52 then contextualizes the query by considering the surrounding context. This may involve, for example, understanding previous queries, the current state of the organizational data, and/or any ongoing trends or patterns. In this step, the QIQ system 42 may use machine learning models to predict the most relevant context, ensuring that the query is answered in a manner that aligns well with the user's needs. After contextualization, the QIQ system 52 conducts data source identification 206, in which the QIQ system 52 identifies the most relevant data sources (e.g., 28, 50) to address the query. The QIQ system 52 has access to various vector data sources (e.g., 36) and repositories, such as databases (e.g., 30, 32, 34), data lakes (i.e., a centralized repository designed to store, process, and secure large amounts of structured, semi-structured, and unstructured data), and real-time data streams. The QIQ system 52 prioritizes data sources based on various factors, such as, relevance to the query, data freshness, and/or accuracy. Once the relevant data source(s) is identified, the QIQ system 52 conducts query execution 208, in which the query is executed across the identified sources. To do this, the QIQ system 52 optimizes the query execution process to minimize latency and maximize efficiency. This may involve, for example, parallel processing, distributed querying, and/or other advanced data retrieval techniques. After retrieving the data, at result compilation 210 the QIQ system 52 compiles the results obtained in response to the query. This can include, for example, ensuring that obtained results are accurate and relevant. The QIQ system 52 may also optionally apply data transformation techniques to convert raw data into meaningful insights. The QIQ system 52 also ranks the obtained results, for example, based on relevance, confidence levels, and/or known user preferences. Finally, at response generation 212, the QIQ system 52 generates a response for the user that is easy to understand and actionable. It presents the results in a user-friendly format, such as a dashboard, report, or visualization. Here, the QIQ system 52 may also provide recommendations or additional insights based on the query results.

The QIQ system 52 interacts with the various data sources in a sophisticated manner that ensures seamless data integration and strategic alignment. To accomplish this, the QIQ system 52 executes processes including data mapping and alignment, real-time data processing, data transformation and enrichment, and integration with existing systems. During the data mapping and alignment, the QIQ system 52 maps and aligns data from the different sources to ensure consistency and coherence. It uses data schemas and metadata to understand the structure of each data source. This mapping process ensures that data from different sources can be integrated and compared effectively. During Real-Time Data Processing, the QIQ system 52 executes real-time data processing, allowing it to incorporate the latest information into its responses. This is particularly helpful for applications where timely insights are essential. The QIQ system 52 can connect to real-time data streams, such as IoT sensors or live transaction feeds, to provide up-to-date insights. During data transformation and enrichment, the QIQ system 52 transforms raw data into meaningful insights by applying data enrichment techniques. This may involve aggregating data, calculating key metrics, and adding contextual information. The QIQ system 52 also ensures that the transformed data is accurate and relevant to the user's query. For integration with existing systems, the QIQ system 52 integrates with existing IT infrastructure, such as ERP systems, CRM platforms, and other enterprise applications (e.g., 30, 32, 34). This allows it to access a wide range of data sources and provide comprehensive insights. The integration process is seamless, ensuring minimal disruption to existing operations.

The QIQ system 52 in some embodiments can significantly enhance the overall effectiveness of the IP4I model 12 by providing enhanced accuracy and relevance, improved user experience, scalability and flexibility, real-time insights, and/or strategic alignment across the educational organization. For example, by intelligently interpreting and contextualizing user queries, the QIQ system 52 ensures that the responses are highly accurate and relevant. This may lead to better decision-making and more effective problem-solving. The system's ability to understand natural language queries and present results in a user-friendly format can improve the overall user experience relative to conventional online educational platforms. Users can interact with the system more intuitively and get the insights they need quickly. The ability to handle large volumes of data from diverse sources makes the QIQ system 52 easily scalable. It can support a wide range of use cases, from simple queries to complex data analysis tasks. In addition, the system's flexibility allows it to adapt to different organizational needs and evolving data environments. The ability to process real-time data can help ensure that users always have access to the latest information. This may be particularly valuable in dynamic environments where timely insights are critical. And, by mapping and aligning data from different sources, the QIQ system 52 may help ensure that insights are strategically aligned with organizational goals, which can lead to more coherent and effective decision-making processes.

A large language model AI (LLM) 60, for example including a generative pre-trained transformer model (e.g., ChatGPT™ by OpenAI), receives output from the QIQ system 52 and generates responsive information (e.g., “answers”) to queries received from any one of the users 38, 40, and/or 42, and/or from other modules within the platform 10 based on the output from the QIQ system 52. The LLM 60 can format the output data from the QIQ system 52 into a more easily understood or logically presented flow, typically in the form of test strings such as sentences and/or paragraphs, for a more user-friendly experience that more closely simulates how the user might receive answers from a real human being.

The integration module 24 includes an artificial intelligence model that is configured to map and align the various entities (e.g., users and departments) and relationships within the educational ecosystem of the education organization. The integration module 24 is configured to identify the entities that interact with and/or otherwise supply information for the platform 10. The integration module 24 is also configured to identify relationships between the entities that interact with and/or otherwise supply information for the platform 10. The integration module 24 can thereby provide seamless data integration and strategic alignment across the entire education organization. In this embodiment, the integration module 24 provides information relevant to three pre-defined areas of the education organization: a business module 54, an organization integration module, 56, and a technology integration module 58. The business integration module 54 is configured to provide integrated information and analysis from across the education organization regarding organizational objectives, assess performance impact, and evaluate strategic agility. For example, the business integration module 54 can help identify if organization objectives are integrated, provide performance impact analyses, and/or provide strategic agility assessments. The organization integration module 56 is configured to provide integrated information and analysis from across the education organization to help enhance change management, cultural readiness, and structure realignment. For example, the organization integration module 56 can help assess change management efficiency initiatives, cultural readiness and adaptation initiatives, and/or structure and role realignment initiatives within the educational organization. The technology integration module 58 is configured to provide integrated information and analysis from across the education organization regarding infrastructure scalability, integration capacity, and/or continuous innovation.

The IP4I model 12 is integrated into the platform 10 to provide a structured approach that can be applied within AI systems to ensure comprehensive coverage of operational elements. In the context of AI, the framework of the IP4I model 12 helps in mapping out how the AI systems in the platform 10 integrate and adhere to these foundational elements to ensure alignment with organizational goals and compliance with standards. The IP4I model 12 maps processes, policies, procedures, and protocols to provide functions and workflows regarding tasks, goals, and data exchange. For process, the IP4I model 12 provides broader sequence of activities to achieve a specific outcome. The processes are the overarching framework in which individual tasks and data exchanges occur within the platform 10. For policies, the IP4I model 12 provides guiding principles that determine how a process is to be carried out, including for example, rules about data handling, user permissions, or other overarching guidelines for the platform 10. For procedures, the IP4I model 12 provides more detail than the processes, such as step-by-step instructions about how a particular task or activity should be completed within a given process. For protocols, the IP4I model 12 provides technical standards and conventions that govern how data is transferred and tasks are executed, which can be particularly important in a digital, automated environment.

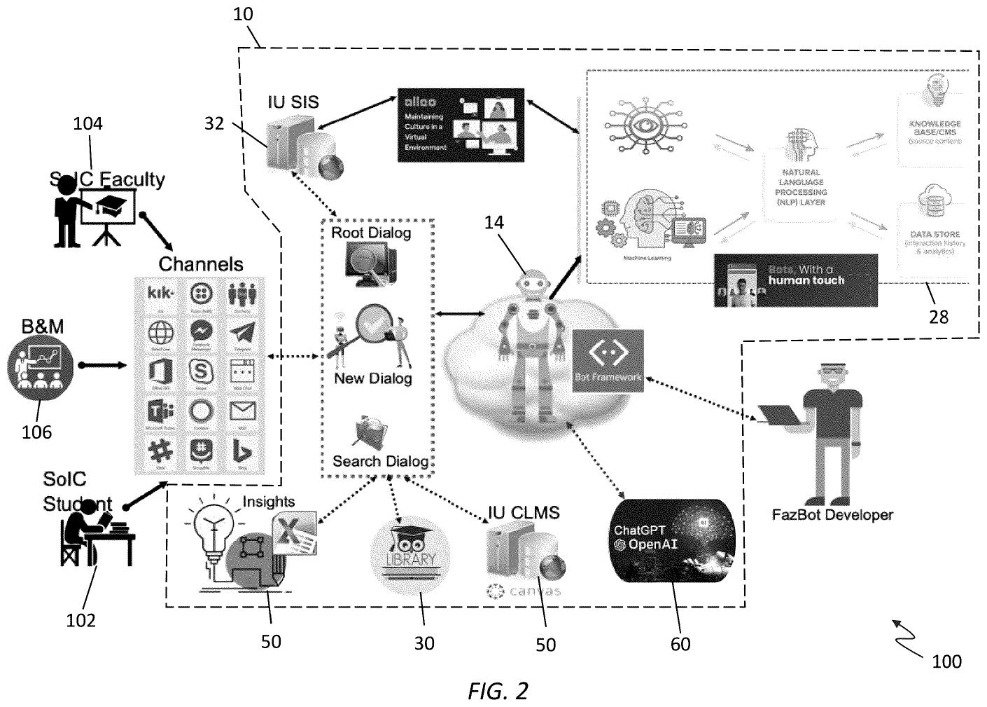

The platform 10 can be used by several different types of users across the educational organization. FIG. 2 schematically represents a use environment 100 of the platform 10 in an educational organization. Each type of user can experience different use scenarios and benefits from using the platform 10 that provides a unique perspective for each user type. For example, the platform 10 can provide different user experiences for each of a student (learner/knowledge assimilator) perspective 102, a faculty (teacher/knowledge departer) perspective 104, an academic advisor perspective 106, and an administrator perspective 108. When using the platform 10, each user interacts with the rapid training and tweaking model 14, for example via the appropriate interface 44, 46, or 48. The rapid training and tweaking model 14 may be thought of as a “digital human.” To help with this, the interface between the AI RGG model 14 and the user may optionally be anthropomorphized, for example by displaying a digital representation (e.g., an “avatar”) having various human-like characteristics on the computer screen of the user's interface 44, 46, or 48. By providing a digital human for the (human) user to interact with, the platform 10 may help make the interaction between the user and the AI RTT model 14 easier and more comfortable for the user. However, the digital human need not have an anthropomorphic visual representation, but may simply have the form of any visual and/or audible interface with which the human user can interact to input information and/or queries to the platform 10 and/or receive information from the platform 10, including by way of nonlimiting examples, text entry screens, graphical information displays, audio receivers and/or delivery systems, dialog portals (with or without animated or non-animated representations), etc.

From the student perspective, the platform 10 provides personalized learning experiences and real-time support through AI agents. For example, the platform 10 is configured to provide automated notifications for assignment reminders and milestone alerts, on-demand support through chatbot integration for real-time (i.e., synchronous) 24/7 query resolution, and personalized messages and follow-ups to enhance student engagement. The AI agent (FTT model 14) can monitor assignment submission portals and send reminders to students for pending submissions. In this way, students receive timely updates about missing assignments, ensuring they stay on track with coursework. The platform 10 integrates the academic calendar with the FTT model 14 to send alerts regarding upcoming due dates. This way, major deadlines are highlighted via automated alerts, aiding in time management for the student. The platform can provide encouragement and follow-up to students. For example, the FTT model 14 can automatically send personalized messages to students after major academic events and milestones. These personalized follow-up notes may help motivate and/or remind students of their academic responsibilities. The platform 10 provides on-demand support, using the FTT model 14 as a chatbot to answer student inquiries at any time and guide the student to relevant legal resources independently of the teacher. In this way, the platform 10 functions as a round-the-clock Teacher Assistant, providing assistance whenever needed, and students have streamlined access to learning resources, enhancing their study experience.

From the faculty perspective, the platform 10 is configured to automatically monitor and report on student engagement and track missing assignments for each student, automatically generate follow-ups and customizable notifications to maintain personal contact with the students and generate at-risk student reports for timely intervention. For example, the platform 10 is configured to track missing assignments and monitor student engagement. These automated notifications alert faculty to students who miss assignments, thereby facilitating early intervention. The platform 10 can provide follow-up notes to students. The FTT model 14 is configured to automatically send follow-up messages or reminders to students based on pred-defined criteria. These automatically generated follow-up notes can strengthen student-faculty connectedness. Faculty can set up personalized bot triggers for different events or student performance indicators. Such customizable notifications allow faculty to maintain personal contact with students at larger scales. The platform 10 can provide at-risk student reports. The FTT model 14 is configured to analyze grades and attendance data to flag at-risk students and compile detailed reports. Such an automated system identifies at-risk students, providing a detailed summary of academic performance for timely support. In addition, resource efficiency and faculty time can be optimized, allowing teachers to focus on students requiring additional help and complex case management.

From the academic advisor perspective, the platform 10 is configured to generate compiled notification summaries for comprehensive overviews, generate alerts for at-risk students based on performance data, and generate detailed student profiles for targeted advising. For example, the FTT model 14 is configured to compile and deliver reports summarizing all communications to and from students and faculty. This allows, for example, generation of comprehensive overviews to advisors with automated summaries of communications, ensuring they are well-informed about student and faculty interactions. The FTT model 14 can be used to identify at-risk students based on performance data for timely advising, thereby enabling proactive advising and support. The FTT model 14 can prepare comprehensive student profiles for academic advisors, highlighting areas that need attention. With such detailed advising triggers, advisors are equipped with detailed, automated reports on student attendance, coursework completion, and academic status for targeted advising.

From the administrator perspective, the platform 10 is configured to generate risk reports for strategic decision-making and operational insights, automatically generate follow-ups to ensure consistent communication with faculty and advisors, and generate customizable alerts for specific events or triggers as defined by the administrator user. For example, the FFT model 14 is configured to generate comprehensive reports on students at risk, utilizing data from various sources for intervention strategies. This can provide operational Insights for administrators gaining a comprehensive view of student risk factors and engagement levels for strategic decision-making. The FTT model 14 is configured to schedule and send automated reminders to advisors and faculty regarding their tasks and deadlines, which can help ensure consistent communication with faculty and advisors, maintaining the momentum of student support. The FTT model 14 is configured to allow administrators to create and manage notification systems for different departments or roles. In this way, administrators can tailor notifications for specific events or triggers, ensuring relevance and timely engagement.

As previously noted above, though the foregoing detailed description describes certain aspects of one or more particular embodiments of the invention, alternatives could be adopted by one skilled in the art. For example, functions of certain components of the computer-implemented educational platform could be performed by components of different construction but capable of a similar (though not necessarily equivalent) function, and various materials could be used in the implementation of the computer-implemented educational platform and computer systems and/or their components. As such, and again as was previously noted, it should be understood that the invention is not necessarily limited to any particular embodiment described herein or illustrated in the drawings.

1. A computer-implemented artificial intelligence (AI) assistant for a computer-implemented educational platform for an educational organization, the computer-implemented educational platform formed by one or more sets of software instructions executed by a computer system, the AI assistant comprising:
an extraction module comprising an AI data extraction agent configured to identify and extract raw digital data relevant to the educational organization from multiple digital data sources;
a transform module comprising an AI data transformation agent configured to receive the raw digital data from the extraction module and transform the raw digital data into transformed digital data having a usable form within the computer-implemented educational platform;
an integration module comprising an AI data integration agent configured to integrate the transformed data from the transform module into a digital knowledge base; and
a manager module comprising an AI agent in charge that coordinates workflow of and dataflow between the extraction module, the transform module, and the integration module.

2. The computer-implemented AI assistant of claim 1, wherein the extraction module, the transform module, the integration module, and the manager module have a hierarchical structure that automates data processing from extraction to transformation to integration.

3. The computer-implemented AI assistant of claim 1, wherein at least one of the extraction module, the transform module, and the integration module comprises a plurality of AI data extraction agents, AI data transformation agents, or AI data integration agents, respectively.

4. The computer-implemented AI assistant of claim 1, wherein the extraction module, the transform module, the integration module, and the manager module are distinct from each other and do not have overlapping tasks relative to each other.

5. The computer-implemented AI assistant of claim 1, wherein the manager module supervises, monitors, and coordinates functioning of the extraction module, the transform module, and the integration module to ensure a smooth and continuous workflow, with each of the extraction module, the transform module, and the integration module passing on data in a streamlined manner.

6. The computer-implemented AI assistant of claim 1, wherein the extraction module is configured to collect data in real-time and/or at scheduled intervals from the digital data sources comprising any one or more internet sites, application programming interfaces, and digital databases.

7. The computer-implemented AI assistant of claim 1, wherein the extraction module is configured to provide data validation including verifying integrity and accuracy of collected data by cross-referencing and error-checking.

8. The computer-implemented AI assistant of claim 1, wherein the extraction module is configured to share validated data with the transform module in a standardized format.

9. The computer-implemented AI assistant of claim 1, wherein the extraction module is configured to coordinate with the transform module to ensure the raw digital data extracted meets predefined minimum standards for further processing within the computer-implemented educational platform.

10. The computer-implemented AI assistant of claim 1, wherein the transform module is configured to perform data cleaning, data enrichment, and data aggregation on the raw digital data received from the extraction module.

11. The computer-implemented AI assistant of claim 1, wherein the transform module is configured to standardize the raw digital data by applying consistent transformation protocols to ensure data uniformity.

12. The computer-implemented AI assistant of claim 1, wherein the integration module is configured to provide at least one of data mapping, data storage, and data accessibility.

13. The computer-implemented AI assistant of claim 1, wherein the integration module is configured to interface with the transform module and the extraction module to maintain a seamless data pipeline.

14. The computer-implemented AI assistant of claim 1, wherein the integration module is configured to continuously monitor one or more data storage systems of the digital knowledge base to ensure the one or more data storage systems are operating efficiently and/or that data in the one or more data storage systems are readily available for querying.

15. The computer-implemented AI assistant of claim 1, wherein the dataflow is from the extraction module to the transform module to the integration module, whereby the extraction module delivers the raw digital data obtained from the digital data sources to the transform module, and the transform module delivers the transformed data to the integration module for loading into the digital knowledge base.

16. A method of hierarchically processing data using the computer-implemented AI assistant of claim 1, the method comprising:
extracting with the extraction module raw digital data from a digital data source;
delivering the raw digital data from the extraction module to the transform module;
transforming the raw digital data with the transform module into transformed digital data;
delivering the transformed digital data from the transform module to the integration module; and
mapping and storing with the integration module the transformed digital data received from the transform agent into the digital knowledge base.

17. A computer-implemented educational platform implementing software instructions executed by a computer system comprising one or more processors and digital memory storage, the computer-implemented educational platform comprising;
a user interface;
a plurality of sources of raw digital data related to an educational organization;
a digital knowledge base; and
the computer-implemented AI assistant of claim 1;
wherein the computer-implemented AI assistant interacts with each of the user interface, the plurality of sources of raw digital information, and the digital knowledge base to:
extract raw digital data from the plurality of sources;
transform the raw digital data into transformed digital data;
store the transformed digital data in the digital knowledge base;
receive queries from the user interface;
retrieve relevant information responsive to the queries from at least one of the plurality of sources and the digital knowledge base; and
deliver the relevant information to the user.

18. The computer-implemented educational platform of claim 17, wherein the plurality of sources comprises one or more databases containing information from one or more departments and/or operational areas of the educational organization.

19. The computer-implemented educational platform of claim 18, wherein the plurality of sources comprises at least one of an internet website, an application programming interface, and a digital database.

20. The computer-implemented educational platform of claim 17, wherein the digital knowledge base comprises at least one of a software library database, a student information system database, a learning management system database, and a vector data sources database.

21. The computer-implemented educational platform of claim 17, further comprising:
a query intelligent query module comprising a questioning protocol that interacts with vector data sources and repositories to contextualize the queries and provide accurate and relevant insights for a user of the user interface in the educational organization.

22. The computer-implemented educational platform of claim 21, wherein the query intelligent query module is configured to implement a questioning protocol comprising:
interpreting the user's query;
contextualizes the query by considering the surrounding context;
identifies the most relevant data sources to address the query;
executes the query across the identified most relevant data sources;
compiles results obtained in response to the query; and
generates a response for the user from the compiled results.
